(19) United States
(12) Patent Application Publication
(10) Pub. No.: US 2003/0112945 A1
(43) Pub. Date: Jun. 19, 2003

(54) System and method for indirect call completion using a personal identifier

(76) Inventors: Wendell Brown, Las Vegas, NV (US); William J. Trenchard, Palo Alto, CA (US)

Correspondence Address: PARK, VAUGHAN & FLEMING LLP, 702 MARSHALL STREET, SUITE 310, REDWOOD CITY, CA, 94063, US

(21) Appl. No.: 10/040,619

(22) Filed: Dec. 19, 2001

(51) Int. Cl. H04M 3/42

(52) U.S. Cl. 379/201.01

(57) ABSTRACT

A system and method for establishing a telephone connection between two parties without disclosing either party's telephone number. The system receives from a first party a call request for a second party. The call request includes an identifier of the second party (e.g., electronic mail address, instant messaging user name) and data concerning the first party (e.g., telephone number, name, picture). The system informs the second party (e.g., via electronic mail) of the call request and solicits the second party's telephone number if not known. If the second party approves the call, the system establishes a telephone connection between them. System subscribers may configure various preferences, including default rules regarding their availability for all or certain types of calls, how to classify calls (e.g., by caller identity, date, time, nature of call). The system may be used to reach a party matching specified parameters (e.g., pizza shop, customer service department).

### BACKGROUND

This invention relates to the fields of computer systems and telephone communications. More particularly, a system and method are provided for establishing a telephone connection between two parties without either party knowing or learning the other's telephone number.

Traditionally, when a caller wishes to establish a telephone connection with another party, he or she dials a telephone number associated with that party. However, the attempted call may fail for several reasons. For example, the called party may be busy or otherwise not available for taking a call, the caller may dial the wrong number, the called party may not be at the number that was dialed, etc.

When a call is placed but not answered, the caller may leave a voice mail message and thereby initiate a round of “telephone tag” as each party attempts to make contact with the other. Or, the voice mail message may be left on a telephone number that the called party checks only infrequently, thus delaying notification of the called party that a call is desired. In many cases, the parties will attempt to contact each other, and may leave a message, several times.

Thus, two inherent problems may be faced when attempting to complete a telephone call—“when” and “where” to reach the other party. More specifically, a caller may have little or no idea of the best time to try to reach his or her desired party, and may not know which telephone number (e.g., office, residence, mobile) provides the best chance of reaching that party at any given time. As a result, the caller may have to dial several numbers and/or leave several voice mail messages before connecting with the desired party.

Some attempts have been made to alleviate the problems of “when” or “where” to reach a party. Voice mail can be left for the called party, for example, and may be translated or transcribed into text or other form for delivery via electronic mail or other means. In addition, “follow me services” attempt to reach a called party at several numbers, perhaps simultaneously, in response to a call. They may try to connect to a called party at one or more telephone numbers, but because they are uninformed as to the called party's availability, they may be unsuccessful at reaching him or her. Existing solutions thus generally address only “when” or “where” to reach a party, but not both.

As another problem, a caller attempting to reach a party may have an identifier of that party, such as an electronic mail address or instant message user name, but not the party's telephone number. Traditional operator services cannot help the caller in this situation because the information possessed by the caller is not enough to enable the operator to locate a telephone number associated with the party. Without the party's telephone number, the caller cannot establish a telephone connection with the party. Therefore, there is a need for a system and method of completing a telephone call between parties when either or both parties do not know the other's telephone number.

In addition, when a caller directs a telephone call to a called party, the called party traditionally receives little, if any, information regarding the caller. The “caller id” service may provide a telephone number or name of a caller, but only if the called party subscribes to this service and the caller does not block the information. In addition, the name provided in a caller id field may not be the name of the actual caller. Thus, there is a need for means for providing one party (e.g., a called party, a caller) with information regarding another party (e.g., a caller, a called party), particularly wherein the other party may configure the information to be provided.

Also, a caller may be frustrated in his or her attempt to reach a particular called party if the telephone system through which the party is accessed employs an IVR (Interactive Voice Response) system. Such systems are often used to offer callers audio menus for reaching different parties or departments within an organization. An IVR system may incorporate many levels, with each choice at a given level determining which options will be presented in the next. When a call is answered by an IVR system, the caller typically navigates the audio menu by pressing telephone keys corresponding to the announced options. It is difficult, if not impossible, to correct an accidental or wrong choice without starting again from the beginning. Besides the possibility of making errors, the caller may be forced to wait (e.g., on hold) for a significant period of time before his or her call is answered by the desired party. Thus, there is a need for a method of facilitating a caller's navigation of an IVR system and/or a method of avoiding having to wait for a desired party to answer a call.

### SUMMARY

Therefore, in one embodiment of the invention, a system and method are provided for establishing a telephone connection between two parties without disclosing to either party the other party's telephone number. The system receives from a first party a call request for a second party. The call request includes an identifier of the second party (e.g., electronic mail address, instant messaging user name) and data concerning the first party (e.g., telephone number, name, picture), but does not include a telephone number of the second party. The system informs the second party (e.g., via electronic mail) of the call request and solicits the second party's telephone number if not known. If the second party approves the call, the system establishes a telephone connection between them. System subscribers may configure various preferences, including default rules regarding their availability for all or certain types of calls, how to classify calls (e.g., by caller identity, date, time, nature of call). The system may be used to reach a party matching specified parameters (e.g., pizza shop, customer service department).

### DESCRIPTION OF THE FIGURES

FIG. 1 is a block diagram depicting a system for automatically establishing a voice connection between two parties based on their availability, in accordance with an embodiment of the present invention.

FIG. 2 is a flowchart illustrating one method of automatically establishing a voice connection between two parties when a call completion system detects their availability, in accordance with an embodiment of the invention.

FIG. 3 is a block diagram of a call completion system configured to automatically complete a call from a subscriber to a party selected based on one or more criteria specified by the subscriber, according to one embodiment of the invention.

FIG. 4 is a block diagram of a call completion system configured to complete a call from one party to another without either party knowing or receiving the other's telephone number, according to one embodiment of the invention.

FIG. 5 is a block diagram of a system for presenting subscriber data to a party, according to one embodiment of the invention.

FIG. 6 is a block diagram of a call completion system for facilitating a telephone connection between a party and an entity accessed through an interactive voice menu, according to one embodiment of the invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

The program environment in which a present embodiment of the invention is executed illustratively incorporates a general-purpose computer or a special purpose device such as a hand-held computer. Details of such devices (e.g., processor, memory, data storage, display) may be omitted for the sake of clarity.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

Automated Call Completion Based on Party Availability

In one embodiment of the invention, a system and methods are provided for receiving a request to establish a voice (or data) connection between two or more parties and automatically establishing a connection between the parties based on their availability. In this embodiment, a call request is received from a first party (a “caller”) wishing to establish a voice connection with another party (a “called party”). The call request may be received via the caller's telephone, VoIP (voice over Internet Protocol), electronic mail, instant message, some other form of electronic communication from a computing or communication device (e.g., a software tool configured for operation with the system, a preprogrammed mobile telephone), etc.

A call request or connection request, in this embodiment, may comprise an identification of the caller and an identification of a called party. Illustratively, the caller's identity may be learned through caller id and/or may be directly provided by the caller or caller's device, while the called party may be identified by an associated telephone number (e.g., work, home, mobile, pager) or some other identifying information provided by the caller.

For example, the system may assign a generic identifier to a subscriber, or the subscriber may request a particular identifier. In this embodiment, a generic identifier may be unique within the system or network that accepts or uses the identifier, but the identifier may bear little similarity to the subscriber's name or other identifying characteristic. Thus, use of a generic identifier may allow call requests to be placed for or by the subscriber indirectly or anonymously without using or revealing personal information regarding the subscriber. A generic identifier may comprise a telephone number, an instant message user name, an electronic mail address, or other information associated with the subscriber. A caller may have multiple generic identifiers, thereby allowing the caller to be identified differently in different call requests.

In an embodiment of the invention, the caller may terminate his or her connection with the system after submitting the call request and providing any other information the system may need to complete the requested call. Other than identities or identifiers of the caller and called parties, required information may include a party's availability, or means of determining the party's availability if such means are not already known. Other call details or criteria, as discussed below, may be required or optional (e.g., quality of service desired by caller, priority of call, call topic) or may be provided as optional information. For example, the caller may specify an expiration date or time for the call request; after that date/time, the call request will be automatically cancelled by the system if not already completed.

The availability of each party may be learned or detected in various ways and at any time. Several methods for determining a subscriber's availability or detecting their presence are described below. For example, while submitting a call request a caller may specify that he or she is (or is not) available for completing the call on certain dates or times or that the call must be completed by a certain time/date. After a call request is placed, a party's availability may be actively evaluated or may be signaled to the system.

A called party may be notified of a call request before the system attempts to satisfy the request, or may need to approve the request, or the call request may be automatically queued for completion in due course. Particularly for a high priority (e.g., emergency) call or a call meeting certain other criteria (e.g., caller identity), the system may attempt to complete it immediately. For example, the system may initiate an electronic communication (e.g., instant message, page, electronic mail) to notify the called party, or directly call the party, to determine if they wish to accept it immediately.

In one embodiment of the invention, the system (or a system tool operating on a subscriber device) may maintain a list of parties for which a subscriber has configured special call completion rules. The subscriber may modify such a list as he or she desires. By way of illustration, such a list may specify that certain pre-approved (or unapproved) parties may (or may not) be connected immediately when they place a request for a connection with the subscriber. In general, a subscriber may establish rules or guidelines for completing (or not completing) a call request, based on virtually any criteria (e.g., caller identity, time, subject of call).

If a requested call is not completed immediately, the system will attempt to complete a call between the parties when it determines that they are available. A subscriber's availability may be determined by applying a set of default rules (which may be customized by the subscriber), by receiving an availability update regarding the subscriber, by determining whether the subscriber is currently using his or her telephone, computer or other communication device, or through another mechanism that indicates whether he or she is available or unavailable.

As described briefly above, a subscriber's availability (or unavailability) may be limited to certain types or categories of calls, or calls matching other parameters or criteria. For example, one parameter for classifying calls may involve priority. A first party may therefore indicate that he is currently available for emergency or urgent calls, but not for routine calls. Another criterion may involve an identity, position or title of another party to the call; a second party may therefore indicate that she is available only for calls with specified parties.

Other categories may involve the nature of a call (e.g., work-related, personal), time or date (e.g., weekday, weekend, day, night, office hours), desired method of call completion (e.g., VoIP, land-line), subject of the call, the identifier of the called party that was provided by the caller, etc. Various other call types, categories and criteria for classifying calls may be derived from the following discussions of various embodiments of the invention.

When the system determines that the parties are available, it may then attempt to satisfy the call request by initiating a multi-legged or conference call. In different embodiments of the invention, different call processing units, switches, gateways, carriers, instant messaging service and other communication systems may be employed to establish the call. For example, the party that will pay for the call may specify or request a desired telecommunication carrier or quality of service (e.g., land-line, VoIP). Illustratively, a call may be billed to the caller, the called party (e.g., for a collect call), or, the system may pay for the call and then bill a party.

When a person subscribes to a call completion system, she may be prompted to provide one or more telephone numbers. In particular, the subscriber may be asked to provide all telephone numbers that she may employ while using services offered by the system. The system may then verify any or all of the numbers. Illustratively, a call request from the subscriber may not be accepted, and/or a call may not be placed to the subscriber unless it is from/to a verified telephone number.

In one method of verification, a code (e.g., a personal identification number) may be assigned to a new telephone number identified by a subscriber. Then, one or more calls may be placed (immediately or after some delay) to the new telephone number. The number is not considered verified until at least one of the calls is answered and the code is entered. In another method of verification, the subscriber may be asked to call a particular number (e.g., an 800 or other toll-free number) using the new telephone line. Through caller id, use of the new line can be verified. The caller may also be asked for a code assigned to the new line.

In another verification method, a verification code may be communicated to a subscriber via electronic mail, instant message or other communication method. The subscriber may be instructed to use the subscriber's new telephone number call a specified telephone number associated with the system—possibly a toll-free number—and input the code. This procedure may be used to verify not only the subscriber's telephone number, but also his or her electronic mail address, instant message user name or other contact information, in one operation.

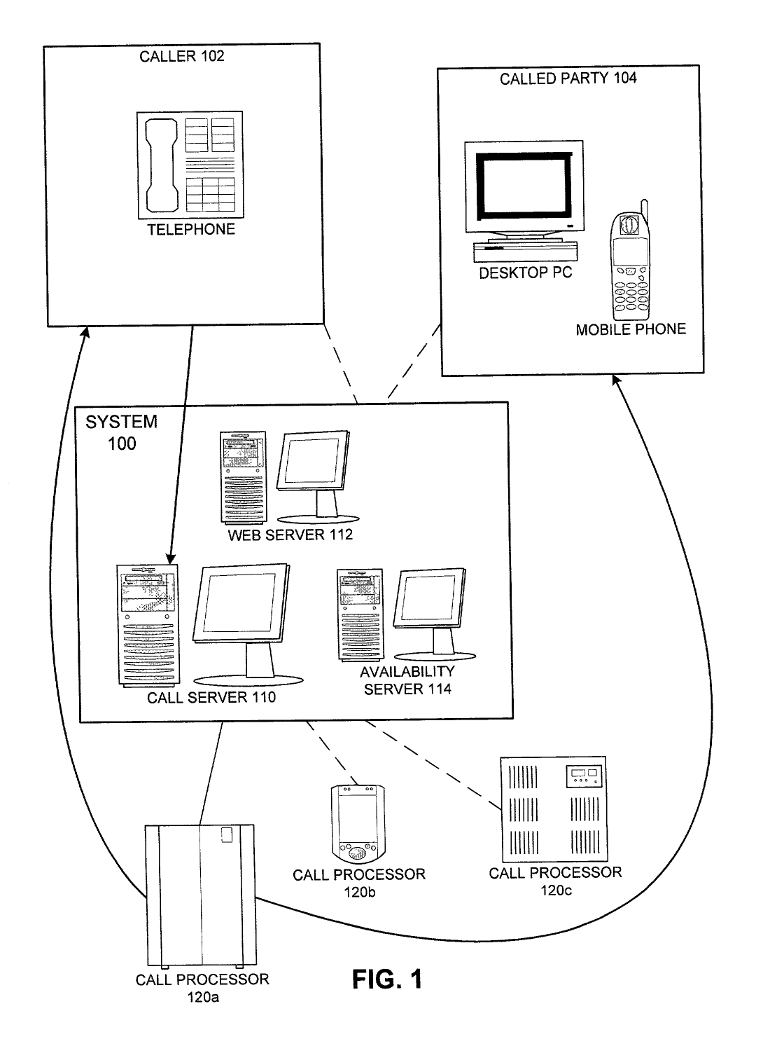

FIG. 1 depicts call completion system 100 according to one embodiment of the invention. In this embodiment, caller 102 and called party 104 are both subscribers to system 100. A system subscriber may be a user of any number of services offered by the system. In an alternative embodiment of the invention, the caller and/or a called party may not be subscribers.

In system 100, caller 102 wishes to have a voice connection established with called party 104, and therefore submits a call request to server 110. Server 110 may comprise a centralized computer system or multiple systems (e.g., a server farm) that may be logically and/or geographically dispersed. Different services of system 100 may be performed by different system servers or multiple servers may have overlapping functions.

Connections between parties 102, 104 and system 100 may comprise telephone lines, wireless links, data and/or voice networks or other communication links. The manner in which server 110 communicates with a party on one occasion or for one purpose or service (e.g., to receive a call request, to determine availability) does not limit or restrict the manner in which the server communicates with the party on other occasions.

The system may provide a toll-free number for the caller's use when submitting a call request, thereby avoiding or reducing cost to the caller and also ensuring that the system receives the caller's telephone number through caller id if he connects via telephone. Because caller 102 is a subscriber, his telephone number may be obtained (e.g., through caller id) and used to identify him and retrieve his preferences, default availability, etc. If caller 102 connects to server 110 via other means (e.g., from a computing device), appropriate identification information may be passed to server 110 (e.g., IP address, electronic mail address, telephone number).

In one embodiment of the invention, a call request may be initiated by a caller by activating a corresponding icon, menu option or other selection in a program provided by the system for operation on the caller's computing or communication device. In another embodiment, software already operated by the caller (e.g., an address book, electronic mail, instant messaging) may be augmented to allow the caller to initiate a call request. Illustratively, the caller may select a called party (e.g., by instant message user name, electronic mail address, contact name) and activate the selection.

If the caller's identity cannot be automatically retrieved through caller id or other source (e.g., IP address from which the call request communication was received), the caller may be required to specify his or her telephone number and/or a security code. Depending on the caller's security settings, he or she may be required to provide the security code with all call requests, all call requests from a particular source, etc.

During his connection with server 110, caller 102 identifies called party 104 with a telephone number, electronic mail address, instant message user name or some other identifier associated with that party. Caller 102 may then terminate his connection with server 110 unless he desires immediate connection (e.g., for an emergency call).

If immediate connection is requested, server 110 may attempt to complete the call as described below, either with or without specifically checking for the called party's availability or obtaining the called party's approval. For example, called party 104 may have configured her preferences or call completion rules to allow emergency calls (or calls meeting other specified criteria) to be placed immediately. Thus, called party 104 may have established a preference indicating that call request from caller 102 may (or may not) be immediately placed.

If an immediate connection is desired (and not prevented by the called party), server 110 may initiate a call to called party 104 and, if she answers, inform her that a caller desires an immediate connection. She may then decide whether to accept it. The system may identify the caller to the called party (e.g., by name, telephone number, a live or recorded voice message). In one alternative embodiment, if called party 104 is operating a suitable computing device, server 110 may initiate a message to the called party at that device, indicating that a connection is desired. Called party 104 may then reject, accept or postpone the call.

If called party 104 is notified of the call request, she may be provided with a greeting from caller 102. The greeting may be a voice recording of the caller, a textual message, a picture or some other electronically transferable information.

In the embodiment of FIG. 1, caller 102 disconnects from server 110 after submitting his call request. Server 110 adds the call request to a list or database of pending requests. If other requests for calls to and/or from called party 104 are pending, the call requests may be prioritized according to various criteria (e.g., callers' assigned priorities, callers' identities, other call parameters), as specified by the called party and/or the system.

When called party 104 is registered as “available” for calls, and one or more call requests for called party 104 are pending, system 100 will initiate calls between the called party and the callers (e.g., in order of priority, time of receipt or other criteria). In this embodiment, server 110 is coupled or connectable to one or more call processors 120. A call processor may be configured to place multi-legged calls or establish a single connection to another telecommunication device.

As described above, different call processors may be configured to establish calls using different telecommunications carriers or network, different qualities of service, etc. Thus, call processor 120c may be associated with a specific telecommunication service provider (e.g., Sprint, AT&T). In one embodiment of the invention, a call processor such as call processor 120a is a general-purpose or special-purpose computer system having a telephone interface card (e.g., such as a card provided by Dialogic Corporation).

In one alternative embodiment of the invention, a device operated by a subscriber may be employed as a call processor. Thus, call processor 120b may comprise a PDA (Personal Digital Assistant), wireless telephone, some other communication device or a hybrid computing/communication device. In this alternative embodiment, system 100 initiates a connection between the subscriber and another party by connecting to call processor 120b (e.g., through a wireless network) and directing the device to call the other party (e.g., using SMS or another suitable protocol). Call processor 120b in this alternative embodiment may be augmented with software, firmware or other programming to enhance its compatibility with system 100.

When called party 104 is “unavailable,” server 110 may await a change in her status before attempting to complete a request for a call with her. Server 110 may detect a status change actively or passively. For example, if the called party's last availability was via her mobile phone, which was turned off (i.e., disconnected from the mobile telephone grid) when she became unavailable, the server may periodically query her carrier's telephone network to determine if she has re-connected. When she becomes available (at the same telephone or some other location), the queries may cease. Similarly, if her last availability was at a particular computing device and she ceased interacting with it when she became unavailable, the server may learn from that device when she has become active again. The system may also actively inquire with other types of communication systems or networks (e.g., an instant messaging system, a wireless local area network) to determine whether a party is available or currently using a particular device or method of communication.

There are many ways for the system to passively detect a change in a subscriber's status from “unavailable” to “available.” For example, called party 104 may directly notify the system in real time. Illustratively, she may do so by telephoning server 110 or initiating some other electronic communication (e.g., instant message, electronic mail, page), possibly using a software tool, utility or agent operating on her computing device. Such a tool may be provided for use with the system and allow her to specify or configure her availability, identify certain categories of calls for which she is available or unavailable, modify her preferences, access her system account, etc. For example, a subscriber may notify system 100, in real-time, that she is unavailable as she goes into a meeting or otherwise becomes occupied. When she leaves the meeting or otherwise becomes unoccupied, she may notify the system that she is again available.

Or, a mobile telephone or other computing or communication device (e.g., desktop or portable computer) may be programmed to send a signal to system 100 to update the system concerning her status. Pressing one button or key may send a first signal indicating that she is available; pressing another may indicate she is unavailable.

If the subscriber's device comprises a telephone, separate buttons may be programmed to dial different system access numbers (e.g., 1-800-Available, 1-800-NotAvailable) and, possibly, submit a subscriber identifier (e.g., particularly if an identifier is not provided via caller id or by her device) and/or security code. In one alternative embodiment, one access number may be used for all availability updates, with a separate availability code being signaled to specify status (e.g., available, unavailable, available for high priority calls or calls satisfying certain criteria). In an alternative embodiment in which multiple people are associated with a single telephone number, different access numbers or availability codes may be employed for each user.

Further, a computing or communication device could be configured to automatically inform system 100 when called party 104 is deemed available. For example, her availability may be assumed when she turns on a particular device, finishes a telephone conversation with another party (i.e., goes on-hook), ends an instant messaging session or video conference, etc. A user's computing or communication device could be configured to monitor her presence or activity to determine if she is talking, typing on a keyboard, etc.

In one embodiment of the invention, a subscriber's availability is signaled when her presence is detected in an instant message system. In this embodiment, her instant message client software may be configured to notify the system when she activates the software. Or, when her presence is detected in the instant message network or elsewhere (e.g., at an instant message client operated by the system or a caller), her availability may then be signaled.

Also, called party 104 may specifically configure rules regarding her availability. Such rules may be included in the party's system preferences. Thus, she may specify that she will be available at her office telephone every weekday for a specified period of time. In this case her availability may be assumed during the specified time unless she overrides this default specification or there is some other indication to the contrary (e.g., she is connected to another call through system 100).

In the illustrated embodiment, server 110 may automatically mark called party 104 as “unavailable” each time it connects her with another party. When she hangs up from one call, she is returned to “available” status. Illustratively, each time a subscriber's status changes from unavailable to available, the system may automatically search for pending call requests involving the subscriber.

When called party 104 is deemed available for the call request from caller 102 (and caller 102 is available), server 110 signals call processor 120a to initiate a call between the parties. The server provides the call processor with the parties' telephone numbers or other access details (e.g., for VoIP), plus any other information that may be needed (e.g., identity of a party to be billed, desired quality of service, maximum length of call). In an embodiment of the invention, a call processor may be included in system 100 instead of being a separate entity.

In one embodiment of the invention, a “pre-call notification” may be sent to a called party and/or a caller before establishing a call. Such a notification may identify another party to the call, indicate how soon the call will be completed (e.g., thirty seconds), etc. A pre-call notification may comprise an electronic mail message, an instant message, a telephone call or some other communication. The notification may be directed to a party's telephone (e.g., via SMS or voice), a system software client/agent operating on a desktop computer, a PDA, a hybrid device, etc. A pre-call notification may embody an option to cancel the call, which may be selected by a called party and/or the caller.

In one implementation of this embodiment, the pre-call notification may include a link or other reference to a subscriber data page providing various information regarding a subscriber. An illustrative implementation of a subscriber data page is described in a following section.

Caller 102 and called party 104 may employ various communication and/or computing devices to submit call requests, update their availability, receive notification of a call request, receive calls, etc. These devices may include traditional computers (e.g., desktop, laptop), PDAs, SMS (Short Message Service) devices, two-way pagers, mobile telephones, etc. Such devices may require special configuration for implementing an embodiment of the invention.

Configuration of a subscriber device may entail programming a telephone with particular code or digit sequences, installing or configuring software or firmware used on a computing or communication device, etc. In one embodiment of the invention, configuring a subscriber's device may include installing, enabling or modifying various existing tools or utilities (e.g., an instant messaging program, electronic mail) or the configuration of a tool specially designed for interacting with server 110 and/or other components of system 100.

In an embodiment of the invention, the system is configured for compatibility with the .NET platform offered by Microsoft Corporation. For example, a subscriber's computing device may be modified (e.g., through the installation of a suitable tool or utility) to integrate system services with various products such as Microsoft Office, Microsoft Outlook, Microsoft Exchange, etc.

The subscriber's call data, settings and/or other information may be maintained as global data within the .NET (or other) platform, thereby allowing the subscriber to access it from any compatible communication or computing device.

In this embodiment, a subscriber's device may maintain various folders or other collections for call requests placed by the subscriber, call requests for the subscriber from other users, approved calls (e.g., calls that have been approved by both/all parties), unapproved calls (e.g., calls requested by other parties that the subscriber has not yet approved), pending calls (e.g., calls for which both/all parties are currently available), archived calls, expired call requests, subscriber settings (e.g., preferences, telephone numbers), etc.

Illustratively, a call or request having one status (e.g., awaiting approval) may be dragged from one folder to another to change its status accordingly. Further, the subscriber may simply drag an object from a program or collection of data (e.g., a list of contacts or electronic mail messages in Microsoft Outlook) to a call request folder (e.g., a folder for new requests) in order to request a call with an associated party. Yet further, a program or user interface may be enhanced with a “call completion” option to initiate a call request with a specified party (e.g., a selected contact, originator or recipient of an electronic mail message, instant message user).

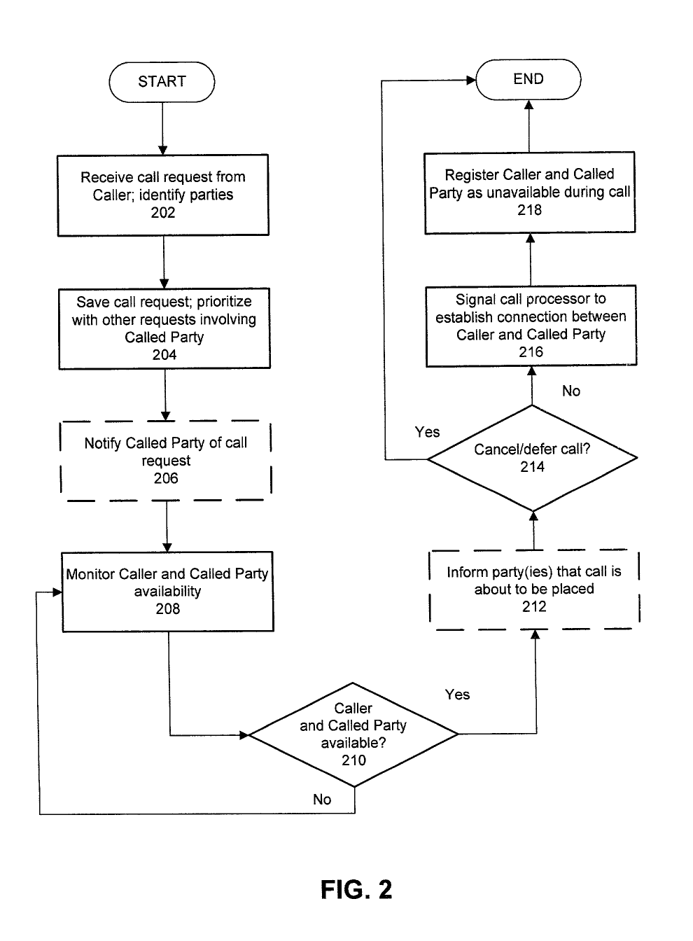

FIG. 2 demonstrates one method of automatically completing a call between two parties in response to a call request from a caller, according to one embodiment of the invention. In the illustrated method, both the caller and called party are subscribers to the call completion system. If either party was not a subscriber, they could be enrolled during or after the process of receiving a call request or completing a call.

In state 202 of FIG. 2, a call request is received from a subscriber. The request may comprise a short communication from the caller, to include her identifier (e.g., telephone number, account number) and an identifier of the called party (e.g., telephone number, instant message user name, electronic mail address). The request may be received in the form of a telephone call, a computer-generated message (e.g., electronic mail, instant message) or some other form.

Besides identifiers associated with the caller and the desired called party, other pertinent data may also be included in a call request, such as a topic or subject, a maximum or requested duration, a suggested time to establish the call, an expiration time or date for the request, etc. Illustratively, a call requested or scheduled for a particular time may be assigned higher (or highest) priority at the scheduled time (if the parties involved in the call approve).

In one embodiment of the invention, a system tool or utility operating on a subscriber's computing device may allow the subscriber to initiate a call request to a party by selecting an entry, in an address book or other list of contacts, that corresponds to the party. For example, a call request icon may be placed on the subscriber's computer, and he or she may drag and drop an electronic mail message, a contact card, or other representation of a party, onto the icon to initiate a call request to that party. Different icons may represent different types of call requests (e.g., call requests with different parameters), such as requests for immediate calls, business calls, personal calls, routine calls, etc.

In an alternative embodiment of the invention, a call may be pre-scheduled or pre-requested. For example, a subscriber may pre-schedule a call to a relative every month (e.g., the 5^{th} of every month), on someone's birthday or a holiday, etc.

In state 204, the call request is saved or queued. If other call requests involving the called party are pending, the present call request may be prioritized according to criteria specified by the caller and/or called party (e.g., priority, type of call, caller identity, time).

In optional state 206, the system may notify the called party of the new call request. This may comprise a pre-call notification described above. Illustratively, notification of the called party allows the called party to accept or approve the call, request the call be connected immediately, assign it a particular importance or priority among other pending calls, cancel it, specify a desired date or time to complete the call, initiate a message to the caller suggesting a particular time to talk, invite another party to join the call, transfer it to another party, etc.

State 206 may be employed in an embodiment of the invention in which the system does not schedule or attempt to schedule a requested call until the request is approved or accepted by the called party (or parties). In this embodiment, a called party is notified of a call request and the system will await his or her approval before scheduling a connection. As just described, when a call request is approved the called party may specify a preference, or override a default preference, that affects how the system would handle the request.

One of a subscriber's preferences or account settings may be to automatically approve call requests meeting certain criteria—e.g., from specific callers, having certain priority, etc. Thus, in conjunction with approving or accepting a call request, a subscriber may alter a parameter of the request (e.g., duration, desired time at which the call should be established, topic). Similarly, a user may choose to automatically handle certain types of calls in a specified manner—perhaps by rejecting call requests meeting specified criteria, postponing or forwarding certain requests, etc.

Among the various information or functions offered by a system tool operating on a subscriber's communication or computing device in this embodiment of the invention, a call request queue may be provided showing uncompleted call requests initiated by (and/or for) the subscriber. Statuses of the requests may also be provided. And, related information may automatically be retrieved when a subscriber receives notification of a call request, such as reverse directory lookup data, name or address information, past calls or other contacts with the caller, etc.

In one embodiment of the invention, a caller (or other party) may be advised as to when he or she may expect a call to be established. For example, a party may be advised that the other party generally becomes available for requested calls within XX minutes of a call request being placed, accepts a particular percentage of calls within a particular period of time, etc.

In state 208 the system monitors the availability of the caller and/or called party. As discussed above, updates regarding a party's availability may be actively sought and/or passively received. Further, default availability may be specified in the subscriber's preferences.

In one embodiment of the invention, a subscriber's computing or communication device may be configured for operation with contact lists, address books, electronic mail, etc. Thus, a subscriber's schedule in Microsoft Outlook may be reviewed to determine whether he or she is busy at a particular time. Or, an instant message network or system may be monitored or queried to determine if the subscriber is engaged in, or has finished, an online conversation.

In state 210 the system determines whether both of the called party and the caller are available. This may involve separate determinations for each party. In the illustrated method, stored call requests involving a subscriber may be examined or updated each time the subscriber changes state from unavailable to available, and/or vice versa. Thus, one party may become available for the call, but the other party may still be busy or otherwise unavailable.

In addition, a party may become available only for calls meeting certain criteria, but this call request may not satisfy those criteria. Until both subscribers are available, the system may cycle through states 208 and 210. When the parties are available to complete this call request, the method proceeds to state 212.

In optional state 212, the called party and/or the caller may be notified that they are about to be connected (and/or when they are to be connected). For example, client or utility software operating on subscriber computing devices may be prompted (e.g., by server 110), an instant message may be sent, etc. In addition, a timer may be triggered to countdown the time remaining until the call is to be established. A party may have the option to cancel the call, defer it, forward it, alter its priority, prepare for the call, etc. The duration of a countdown may be one of the parameters a subscriber may configure.

In state 214, the system determines whether the call should be cancelled or deferred because of a party's action. As described immediately above, a party may take such action when notified that the call is to be established. Alternatively, the system may learn that a party has become busy (e.g., the party initiates a call or other connection) or an update to the party's availability may be received (e.g., the system may be notified that a party turned off a mobile phone that was to be used to establish the call).

In state 216, the parties are available and satisfaction of the call request may proceed. Therefore, the system (e.g., server 110 of FIG. 1) signals a call processor to establish a connection between the caller and called party.

If one of the party's telephone lines is busy when the connection is attempted, the system may take various remedial actions. For example, the system may retry the same line one or more times, attempt to use an alternate line that is already known to the system or that is elicited in real time, re-schedule the connection for a later time, etc. If the connection must be postponed, either or both of the parties may be notified.

In state 218, while the call is ongoing, the parties are considered unavailable for other calls. However, while engaged in a call, a party may be able to submit call requests, add or invite another party to the call, forward the call, etc.

The method of FIG. 2 is only one method for completing a call between two or more parties, in response to a call request, based upon their dynamically determined availabilities. Other suitable methods may be derived from the preceding and following descriptions without exceeding the scope of the invention.

In one embodiment of the invention, after a call is completed between two parties, one of the parties may transfer the call (with or without the other party remaining connected) to the system. This may be done in order to submit another call request, access a party's preferences, access subscriber data for a party, or use some other service offered by the system. When connected to the system, a party may be linked to an operator, an interactive calendar, an automated system offering directions, reservations or other information, an interactive address book, etc. Along with, or instead of, transferring a voice connection to the system, the party may access the system via a web server or other computer-based interface.

In another embodiment of the invention, a task list or reminder list of calls may be maintained for a subscriber. Illustratively, the subscriber may schedule or list calls that he or she wishes to make—on a one-time or repeating basis. At the indicated time, a regular call request may be generated. The subscriber may be required to approve generation of the call request or the request may be automatically generated unless the subscriber cancels or changes it. A notification may be issued to the subscriber (e.g., to remind her of the reason for the call) when the call request is generated and/or when the call is to be established.

As described above, subscribers may set various preferences or rules regarding their availability, the calls or types of calls for which they are available or unavailable, how to classify calls directed to the subscribers, etc. System 100 of FIG. 1 thus includes web server 112 to provide users and subscribers with an automated interface to access the system through a public-switched network.

Illustratively, web server 112, which may be part of server 110 in an alternative embodiment, allows a subscriber to configure his or her preferences, notify the system of his or her availability, place call requests, review pending call requests involving the subscriber, etc. Any of these functions may also be performed on a computing or communication device (e.g., desktop computer, hand-held computer, personal data assistant, telephone) equipped with suitable tools for interacting with system 100.

System 100 includes availability server 114 to determine or track the availability of a subscriber or user. Any or all of call server 110, web server 112 and availability server 114 may operate on the same computer system(s). The various components of system 100 may communicate among themselves as necessary to receive, process or complete call requests.

In an embodiment of the invention, criteria for categorizing or classifying calls (or call requests) may include some or all of the following: priority (e.g., urgent, routine), caller identity, whether the call is personal or business-related, the date or time of the call request, method or quality of desired connection, voice vs. data connection, etc. And, a category may include sub-categories. Thus, within a business category there may be sub-categories dealing with types of business-related calls, such as technical support, customer service, administrative, client-initiated calls, calls from a boss, etc.

Further, calls may be cross-categorized or cross-classified according to multiple criteria. For example, a personal call from one person may be assigned a priority different than a personal call from another person, a subscriber may specify that he is available for a business call during the week but not on the weekend, unless it is from his boss, etc.

When the system places a call requested by a subscriber, it may populate a caller id field (e.g., caller ID number, caller ID name) with various information. In one embodiment, the system may insert a telephone, name (e.g., text) or access number associated with the system. In another embodiment, a number and/or name associated with another party to the call may be inserted. In yet another embodiment, numbers and/or names associated with both the system and the other party may be included. The specific contents may depend upon the preferences of the party being called, whether the party may initiate a return call (e.g., *69) if he or she does not answer the call, and so on. In an alphabetic portion of the caller id field, the system may identify itself, another party to the call, etc.

In one embodiment of the invention, a subscriber may choose to accept only calls placed through the system (as opposed to direct calls from a caller). As one benefit, this allows him or her to filter or screen calls with greater particularity than conventional systems (e.g., voice mail). If the subscriber blocks all non-system calls, or has them forwarded to the call completion system, then a telephone number and/or name may be placed in a caller id field (of the connection from the system to the subscriber) to prevent the call from being blocked. Alternatively, a subscriber may allow calls that are not received through the system to be passed to a voice-mail system. Illustratively, the voice-mail system may then play a greeting that invites the caller to contact call server 110 to reach the subscriber.

When a call involves more than two parties, in one embodiment of the invention it may not be established until all parties are available. Alternatively, a request for a call among more than two parties may specify that it should be set up at a particular time (or within a range of times) with whatever parties are available, that it should be set up whenever a minimum number of parties are available, when specified “required” parties are available, etc. When a call involving more than two parties is established and not all desired parties are in an “available” status, one or more of the “unavailable” parties may be contacted (e.g., via telephone, instant message, electronic mail, another automated notification) and invited to join or make themselves available for the call.

A call completion system such as system 100 of FIG. 1 may also be used to request and complete calls involving users who are not already subscribers to the system. If, for example, a caller is a subscriber but a desired party (i.e., a called party) is not a subscriber, a call request may be placed as usual except that the caller may be required to provide one or more telephone numbers of the called party. The system may then attempt to complete the call immediately to any or all of the supplied numbers. In addition, the called party may be invited to subscribe to the system. Illustratively, the caller may provide the system with one or more electronic mail addresses, instant messaging user names or other identifiers to allow the system to invite the party to join the system.

If a called party who is not a subscriber is unavailable (e.g., does not answer a call completion attempt from the system), the system may leave a message announcing a desired call and inviting the party to contact the system to complete it. When the called party contacts the system (e.g., via telephone, via a system web server), the system may attempt to complete the call.

Also, the system may register the called party as a subscriber or at least attempt to gather information regarding his/her availability (especially if the caller is unavailable when the called party contacts the system to complete a call). Non-subscribers may be sent electronic mail, instant messages or other communications to invite them to register, access system web server 112, provide availability information, etc.

If a person wishing to use the system to complete a call is not a subscriber, but a desired called party is, in one embodiment of the invention the system will elicit enough information to identify the called party and to connect the caller when the called party is available. The system may therefore elicit caller availability information while taking the call request. The caller may also be invited to register as a subscriber thereby allowing the system to obtain more availability information (e.g., automatically), set the caller's preferences, etc.

In an embodiment of the invention, when a non-subscriber wishes to use the system or a call request is placed to a non-subscriber, the non-subscriber may be required to register with the system (i.e., become a subscriber) in order to establish his or her call. Or, a non-subscriber may be limited to a certain number of calls connected through the system, or the use of limited services, before he or she must subscribe.

In one embodiment of the invention, one or both of a caller and a called party may charge a fee in conjunction with a connection. Such a fee may be in addition to any fee charged by the system for establishing the call. In this embodiment, if one party requests or requires a fee, the system may report the fee to the other party for his or her approval before the system will complete the requested call. If a third party is requested to pay a fee, the third party's approval may be required before the call is established. The third party may, however, establish rules for allowing some fees (e.g., for calls involving particular parties) to be automatically approved.

Illustratively, a caller may specify a required fee when placing a call request, and/or a called party may specify a fee when accepting or approving a call request. Alternatively, a fee may be requested when the system initiates the call. The fee may be a flat fee or may be assessed per unit of time (e.g., each minute, half hour, hour). A party that charges a fee may do so for any of various reasons e.g., in exchange for the party's participation in a call (or the participation of a representative or associate of the party), for information to be exchanged during a call, or for any other reason, which may or may not be communicated to the other party.

In this embodiment, a subscriber may set his fee (or a range of fees) in his system preferences and specify which types or categories of users (or specific users) are, or are not, to be charged. Illustratively, the fees owed by a party may be automatically charged to a credit card or other source (e.g., a bank account, a PayPal account), or may be paid through the system. The method of paying a fee may be identified before or after the call is established.

Automated Call Completion to a General Party

In one embodiment of the invention, a system for completing calls (e.g., system 100 of FIG. 1) may be used to reach a party matching user-specified selection parameters rather than a specific party (e.g., a person) identified by a telephone number or other identifier. For example, in this embodiment a user may employ the system to locate a merchant of a particular good or service, a type of good or service, a representative of an organization, etc.

To initiate the connection request, a user may contact the system via telephone (voice), instant message, electronic mail, or some other form of electronic communication from his or her computing or communication device. To identify a desired party, the user may specify a type or category of good or service (e.g., pizza, florist, airline), a brand (e.g., Pizza Hut, American Airlines), a division or department within an organization (e.g., Pizza Hut catering, American Airlines reservations, local telephone company repair service). In one embodiment, the user contacts the system, identifies himself, specifies his selection parameters and may then hang up or end his connection with the system.

The system then contacts a party meeting the selection parameters and either establishes a connection (e.g., voice, data, instant messaging) between the parties or has the desired party call the user. As with other automated call completion methods described above, the availability of the user and/or a suitable target party may be obtained and considered in determining when to connect the parties or when to have the desired party call the user.

When a subscriber makes use of the system to contact a party meeting certain parameters, he or she may avoid having to wait (e.g., on hold) for an operator or agent of the party. Instead, the system allows a call between the parties to be established when both are available. Illustratively, a subscriber's initiation of a connection request for an organization that maintains a queue for incoming calls may be sufficient to place the subscriber in the queue. The call request then works its way through the queue and he or she may be contacted when his call makes it to the front of the queue.

Illustratively, when a representative of an organization answers the call, he or she may be given or played a message advising them that a customer is being connected. Or, the representative may be invited to press a key sequence (e.g., “1”) in order to connect to the customer. Alternatively, if the system receives information indicating when the representative will be connected (e.g., a countdown timer), then the user may be connected shortly before the representative answers. In addition, a method of facilitating navigation of an organization's IVR (Interactive Voice Response) system is provided in a subsequent section.

When the system receives a call request from a user for a called party identified by selection parameters (e.g., rather than a telephone number), the system may consider the user's location when selecting an appropriate vendor, merchant or other organization meeting the user's parameters. The location information may be specifically provided by the user, may be assumed based on the user's method of contact (e.g., from a home telephone number, from her office computer (e.g., as determined by IP address)), may be determined with the aid of GPS (Global Positioning System) if the user is operating a mobile phone or other suitably equipped device, or may be ascertained in some other manner.

Thus, if a user requests a call with a pizza shop (and does not specify a brand), the system may attempt to locate the closest pizza shop, the closest pizza shop with a satisfactory rating, the pizza shop that pays the highest fee for customer referrals, etc. Ratings on which to base user referrals may be derived from user comments or ratings of a third party, may correspond to the response time of the organization in handling previous customers, etc.

Also, the system may consider an organization's availability when selecting a suitable party to connect with a user. The availability may pertain to the organization's ability to accept the connection and/or provide a desired good or service. For example, if a pizza shop is requested the system may contact a particular pizza maker (e.g., via telephone, instant message, other electronic communication) to determine its response time. If it cannot offer delivery or call completion within a particular period of time, the system may consider a different organization. Or, the system may offer the user multiple choices, along with their availabilities, response times (e.g., average, median), rating, location, cost, etc.

In another embodiment of the invention, the system may be configured to handle all calls, or any subset of all calls, on behalf of a vendor, merchant or other organization. For example, an organization may have all calls meeting specified criteria (e.g., calls for customer support, calls to order merchandise) forwarded to the system. The system then places the caller in touch with a customer service agent or other representative of the organization when available.

In an embodiment of the invention in which the system receives location information regarding subscribers (e.g., through GPS, a subscriber's mobile telephone carrier), a subscriber may be notified when he is near a party (e.g., another subscriber) or organization (e.g., vendor, service provider) in which he has an interest. More particularly, the subscriber may be alerted to the proximity of a subscriber or organization he has been connected with previously or has otherwise indicated (e.g., through preferences) a desire to interact with.

For example, if he has specified a desire to become acquainted with someone meeting particular parameters (e.g., any person affiliated with a specified organization or a particular department in an organization, women in a certain age range, other subscribers in the same profession), he may be automatically notified by the system when such a person is near. The details that may be specified by a subscriber may depend upon the preference options available to subscribers and/or other information obtained by the system regarding its subscribers and/or identified organizations.

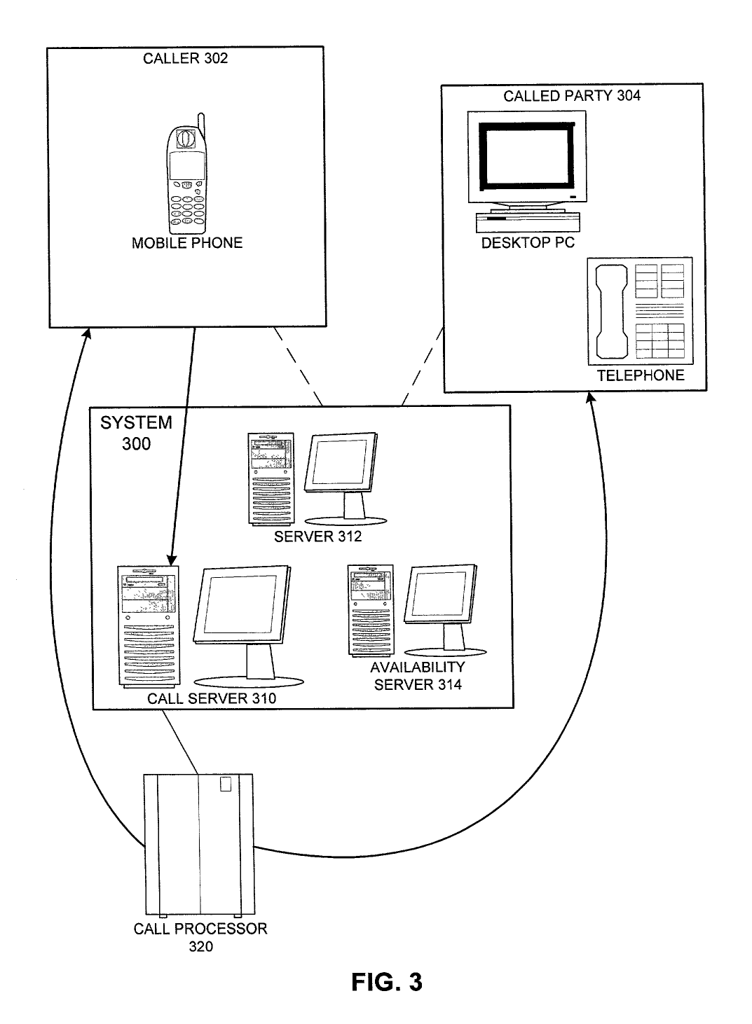

FIG. 3 illustrates one embodiment of a call completion system configured for establishing a call between a subscriber and a general party. Call server 310 of system 300 receives a call request from caller 302, wherein the request includes one or more criteria associated with called party 304. Server 312 and/or availability server 314 may use various information, as described above, for selecting called party 304 from candidate parties for the requested call. Server 312 may evaluate or rank candidate parties using the subscriber's criteria, consumer rankings, fees paid by the parties, etc. Server 312 may also use availability information gathered by availability server 314 regarding a party's ability to handle the call, the party's response time, etc. When called party 304 is selected, system 300 may signal call processor 320 to establish the call.

Indirect Call Completion Using a Personal Identifier

In one embodiment of the invention, a party may protect a telephone number from being disclosed by providing it only to a call completion system (e.g., call completion system 100 of FIG. 1) configured for establishing an indirect call. An indirect call may be defined as a call placed to a party without knowing that party's telephone number.

In this embodiment, a person wishing to establish a call with a party does so by providing the system an electronic mail address, generic identity (e.g., account number) or other identifier (e.g., an instant messaging identity) associated with the party. The system then retrieves the party's telephone number(s) or other means of connecting him and establishes a telephone connection between them.

Thus, in one implementation of this embodiment, an indirect call may be placed through the system without one or more of the parties to the call knowing or receiving a telephone number of another party. Further, a system subscriber may have all calls (or certain calls) forwarded to the system, to allow the system to handle their completion and thereby protect her telephone number(s). The system may store telephone numbers of one or both parties for future use. However, in this implementation, neither party to an indirect call is given another party's telephone number (unless the other party specifically approves such action).

In an illustrative implementation of this embodiment of the invention, a caller wishing to reach a particular party (i.e., a called party) contacts a call completion system and submits an electronic mail address of the called party. The caller may also enter information identifying him or her (e.g., name, electronic mail address, telephone number) if he or she is not already a subscriber or known to the system. To submit the necessary information, the caller may access a web site associated with the system or the called party (e.g., a subscriber data page as described in another section), may send an electronic mail message to the system, may submit a call request, etc.

Any or all of the information may be verified. As described in a previous section, a party claiming association with a telephone number may have to call the system from that number, may be required to provide a confirmation or authentication code or other information. The confirmation code may be provided to the party via electronic mail, instant messaging, paging or other means, thereby enabling verification of additional communication means.

In the indirect call request, the caller may also be able to enter a greeting or other message (e.g., in text, audio or video), such as a picture, to be presented to the called party. Also, the caller may set an expiration date or time for the requested call, specify his or her availability for the call, identify a topic for the call, etc.

The call completion system then sends one or more communications (e.g., an electronic mail message, an instant message) to the called party to inform him that the caller wishes to talk to him. If no response is received to a first form of communication (e.g., an instant message), another form may be attempted (e.g., electronic mail). A communication may be directed to various devices (e.g., a computer, a communication device via WAP (Wireless Access Protocol) or SMS (Short Message Service))

In the communication, the caller may be identified by the information he or she provided and/or other information known to the system (e.g., a photograph). The communication may include a URL (Uniform Resource Locator) or link (e.g., a hyperlink) to the call completion system (e.g., web server 112 of system 100) or other site (e.g., a subscriber data page), an embedded HTML form, a link to select to initiate an immediate connection with the caller and/or other information.

In the communication sent by the system, the called party may be prompted to provide a suitable telephone number to which the caller should be connected. In response to the communication, the called party may cancel the request, defer it, forward it to another party, request a topic be specified, specify a fee that must be paid for the call, etc. If the called party wishes to forward the call request or add another party, this may generate a new call request or the other party may be added as a called party to the present call request. The called party may be connected to the system (e.g., call server 110 of system 100) to forward or extend the call.

If approved by the target called party, the call completion system may then attempt to complete the call immediately or schedule the call as requested by the called party or the caller, complete the call when both parties are deemed to be available, etc. If the called party requested additional information, or the caller must agree to a call parameter (e.g., a fee to be paid, a time limit) the request may be sent to the caller or the system may apply default rules or party preferences.

If either or both of the caller and the called party are system subscribers, then the system may already know one or more telephone numbers for connecting them. And, the indirect call request may then be treated similarly to the handling of a call request as described in a previous section. For example, the called party's availability (and/or caller's availability) may be examined to determine when to place the indirect call, the called party may or may not be notified in advance, either party may specify a desired quality of service (e.g., land-line, voice over IP), etc. If the called party has specified preferences for handling particular calls (e.g., automatically approve or deny call requests from particular callers), those preferences may be applied.

In other embodiments of the invention, the caller may identify the called party to the call completion system using an identifier other than an electronic mail address. Other possible identifiers include an instant message user name, a chat name, a user id, a street address, a license or registration number (e.g., of a car or airplane), an identifier assigned by or for the call completion system, etc.

A call completion system for indirect calls may be implemented in conjunction with an online chat service, an instant message system or some other service that associates unique identifiers with its users. Thus, a chat or online discussion service may include an agent or tool for establishing a voice connection between two participants according to one of the methods described herein. Even though each participant only knows the other's online identifier, they can be connected telephonically.

Another embodiment of a call completion system for indirect calls may be employed with an online auction system to allow a bidder to contact someone offering a good or service for sale. The bidder may identify the party he or she wishes to contact (e.g., to discuss an item) using an identifier of the good or service.

A subscriber may have more than one generic or personal identifier. Each identifier may be used as another parameter for classifying call requests. For example, one set of friends or associates may be given one identifier to use when submitting a request for a call with the subscriber, while another set of associates is given a different identifier. The subscriber may then set a preference to prioritize handle call requests comprising those identifiers.

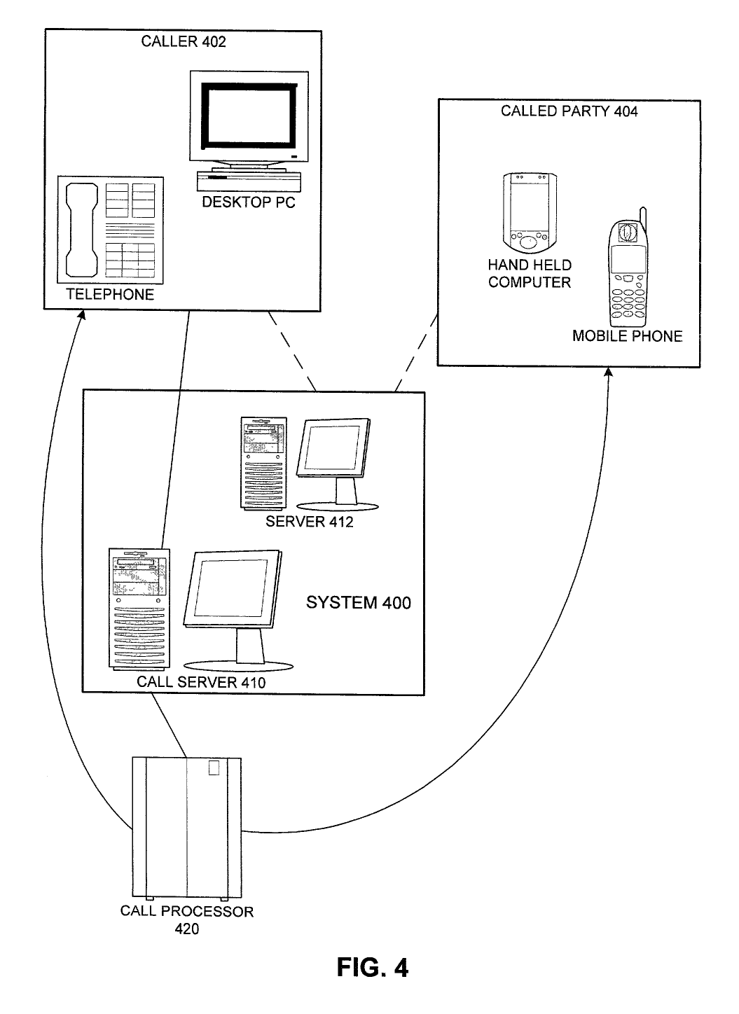

FIG. 4 illustrates one embodiment of a call completion system for establishing a call between two parties in response to a call request from a first party that identifies the other party without using a telephone number. As in system 100 of FIG. 1, system 400 includes call server 410 for receiving call requests and/or initiating calls using a call processor or a party's communication device. Server 412 may be configured to track a party's availability, provide an interface to system 400, notify a party of a requested call, handle the forwarding or expansion of a call (e.g., to add a party), etc. Caller 402 and called party 404 may employ various communication and/or computing devices for interacting with system 400 and/or each other.

Subscriber Data Page

In one embodiment of the invention, a call completion system (e.g., system 100 of FIG. 1) hosts or facilitates access to a subscriber data page. In this embodiment, a subscriber data page may comprise a collection of subscriber data that another party may access electronically. Thus, in one implementation a subscriber data page may be reached through a publicly accessible network (e.g., the Internet) using a suitable browser or other appropriate interface. Subscriber data pages may be configured for access via HTTP (HyperText Transport Protocol) or HTTPS (Secure HTTP), WAP (Wireless Access Protocol) or various other communication protocols.

In the call completion system of FIG. 1, a subscriber data page may be maintained on call server 110, web server 112, another computer system associated with system 100 (e.g., a server specifically configured for maintaining or service subscriber data pages) or a computer system associated with the subscriber.

A subscriber's data page may be accessed by a target of a call request placed by the subscriber (i.e., a called party)—such as a merchant, a caller who has placed (or wishes to place) a request for a call with the subscriber, or some other party (e.g., a member of the general public). Illustratively, a party wishing to access a subscriber's data page provides an electronic mail address or other identifier of the subscriber (e.g., telephone number, user id, name).

One embodiment of a subscriber data page may be configured to display virtually any information that the associated subscriber wishes to reveal, such as: name, address, telephone number (e.g., for voice, facsimile, modem), electronic mail address, instant message user name, credit card data, bank account data for electronic banking, time zone, etc. Such data may be in various forms, including text, graphics (e.g., a photograph of the subscriber), video and sound (a voice greeting by the subscriber).

The content of a subscriber's data page may include dynamic as well as static information. For example, analysis of the subscriber's call completions may be displayed to show how quickly the subscriber approves or accepts calls, responds to electronic mail messages or instant messages, etc. Other dynamic information that may be provided may include the subscriber's current availability for calls, whether the subscriber is online for instant messaging, etc.

The subscriber may configure his data page to display different data for different parties accessing the page. Thus, some information may be displayed for all parties, such as a photograph and an electronic mail address. Additional information may be displayed for specific parties (e.g., friends, relatives), such as telephone number(s), mailing address, a private electronic mail address, etc. Yet other information may be displayed for merchants accessing the page in response to a call request from the subscriber, such as shipping address, credit card data, etc. In general, some parties—such as targets of call requests from the subscriber, parties specifically identified by the subscriber—may be provided with more information than an unknown party or member of the general public.

Illustratively, the system may know which category or class a party belongs in, and therefore ensure that only appropriate subscriber data is displayed for the party, based on the subscriber identifier provided by the party. As described above, different parties may be given different subscriber identifiers to use when the party needs to identify the subscriber to the system. In addition, if the party is accessing the subscriber's data page in connection with a call request handled by the system, the system knows the party's identity and can classify the party appropriately.

Thus, in one implementation of this embodiment, a subscriber places a call request for a merchant or vendor—which may be identified specifically (e.g., by name or telephone number) or generally (e.g., by type of good or service). The call completion system sends to the specified or selected merchant a link or reference to the subscriber's data page.

For example, shortly (e.g., 30 seconds) before the call is to be completed, the system may send the merchant a pre-call notification containing a link to the page (e.g., via instant message or electronic mail). In one implementation, a pre-call notification will be directed to a software tool, client or agent installed on a computing device operated by the merchant. Alternatively, information for accessing a subscriber data page may be provided through a caller id field of a telephone connection from the system.

After being informed of the subscriber's data page, the merchant can then access the page to retrieve necessary data and thereby avoid having to elicit such information directly from the subscriber. The link/reference to the subscriber's data page may be provided before, during or after the merchant's connection with the subscriber.

A pre-call notification to a party may therefore include more than just an identity or identifier of another party to the call. The notification may comprise a link to the other party's subscriber data page, an option to delay call completion, an option to link the other party's personal data with the party's order processing system (if the party is a merchant), an option to complete the call as soon as possible, etc.

In another implementation of a subscriber data page, the subscriber may dynamically (e.g., during a telephone connection) approve the release of additional information to another party through his or her data page. Thus, while submitting an order to a merchant, for example, the subscriber may authorize the system to display the information (or provide telephonically or through another data link).

Another implementation of a subscriber's data page may be employed with a method of indirect call completion (e.g., as described in a previous section). Illustratively, a chat room participant, instant messaging partner or other known, unknown or anonymous party may be provided with a link or reference to a subscriber's data page. These types of parties may be granted access to a photograph of the subscriber, employment information, age, etc. Thus, the subscriber can protect her identity even while selectively disclosing other information.

In another implementation, a call completion system may be linked with a merchant's order processing system. Thus, when the system connects a subscriber with the merchant, the order processing system may be automatically provided or linked with the subscriber's relevant data.

The system may be configured to validate merchants to ensure that a subscriber's credit card or other financial or billing information is not compromised. Further, the system may validate information included in a subscriber's data page. For example, correspondence may be sent to a mailing address or electronic mail address identified by the subscriber to ensure that he or she is available at that address, a telephone call may be placed to a subscriber telephone number, a credit card account may be verified with an issuer, etc.

In yet another implementation, a subscriber's data page may identify a fee that the subscriber charges to participate in a connection with a party. In this implementation, when a caller submits or wishes to submit a call request for the subscriber, the caller may access the subscriber's data page to determine if a fee will be assessed, and the amount of the fee. Illustratively, the caller may be required to approve or agree to pay the fee in order for the system to accept his or her call request (and identify a method of payment). Because the subscriber's data page may be configured to display different information for different parties accessing the page, different fees may be required of different parties, and some parties may not be charged at all.

Similarly, a party receiving a call request from a subscriber may access the subscriber's data page to determine whether a fee will be assessed (e.g., if such information is not included in a call request notification sent to the party).

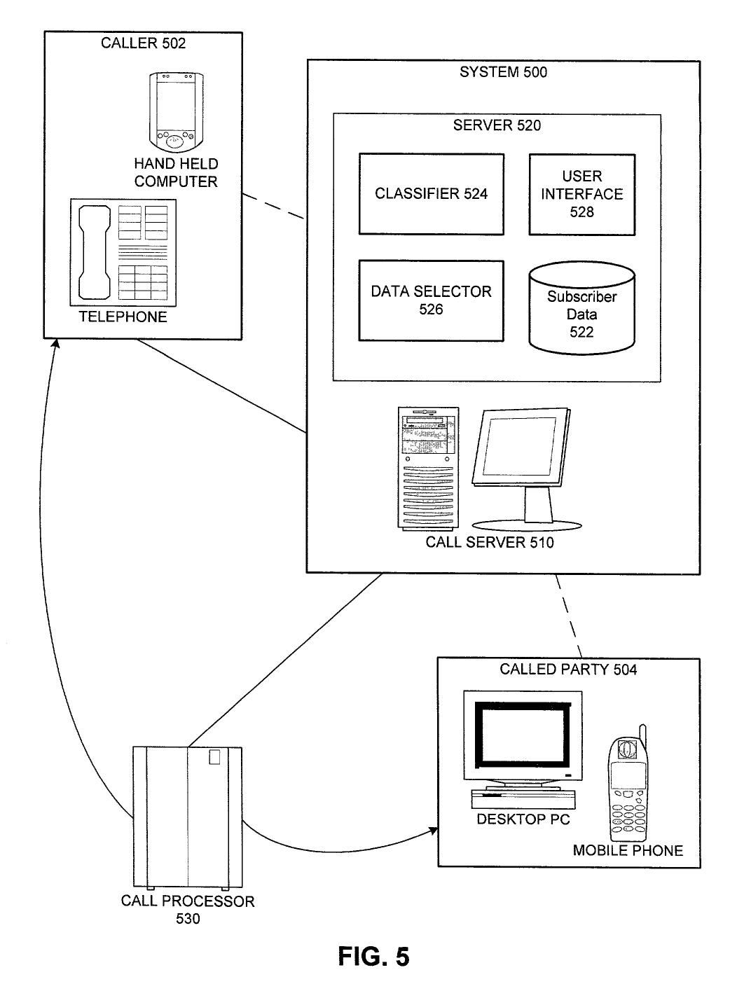

FIG. 5 depicts a system for facilitating access to a subscriber data page, according to one embodiment of the invention. System 500 comprises call server 510 for receiving call requests and/or initiating call connections using a call processor or a subscriber's communication device. Caller 502 and/or called party 504 may employ various communication and computing devices for interacting with system 500.

System 500 also includes server 520 which may perform various functions of the web server and/or availability server of system 100 of FIG. 1. In particular, however, server 520 is configured to offer access to subscriber data. In this embodiment, server 520 stores subscriber data pages in database 522 or in some other form. Classifier 524 may classify parties requesting access to a subscriber data page according to their identities, methods of access, and so on. Classifier may also classify or categorize subscriber data as it is received or stored. Data selector 526 ensures that only suitable subscriber data is presented to the accessing party, based on the subscriber's settings. User interface 528 enables a subscriber to customize his or her data page and/or present data pages to parties requesting access.

Interactive Voice Response (IVR) Navigation

In one embodiment of the invention, a method of navigating or facilitating the navigation of an IVR (Interactive Voice Response) system is provided. In this embodiment, a caller may be connected to an organization's IVR system in a direct call to the organization or via a call placed through a call completion system such as system 100 of FIG. 1. Different options or benefits may be available to a caller depending on which type of call is placed.

Illustratively, an organization that receives a large number of calls for technical support, customer service, automated information retrieval or other types of services may employ an IVR system. The system will generally provide audio announcements to a caller directing the caller to press certain telephone keys to navigate the system. At each level of the overall IVR menu, the caller may be presented with one or more options. Selecting a particular option may bring up yet another level of choices, connect the caller to a party (e.g., a human) or information source (e.g., an automated system) matching the caller's choices, or place the caller in a wait queue for such a party.

In one implementation of this embodiment, the options presented by an IVR system are presented to a caller graphically and/or audibly (e.g., on a computing or communication device), in real-time or off-line.

In a real-time presentation, a call completion system (e.g., call completion system 100 of FIG. 1), some portion of a call completion system or another suitably configured system, telephonically connects the caller to the organization's IVR system and translates or maps the options (e.g., into text) as they are presented by the IVR system. Alternatively, the call completion system may be connected to the call after it is established between the caller and the organization. The caller's real-time choices are fed back to the IVR system.

In an off-line mode of presentation, call completion system 100 or some other suitably configured system maps the organization's IVR system before the caller is connected to the organization. For example, the caller may place a call request for the organization and inform the call completion system that the organization employs an IVR system. Or, the system may already know or otherwise determine that an IVR system is used. For example, the call completion system may regularly call different organizations to determine if they use IVR systems.

Regardless of how the call completion system learns that an IVR system is employed, it may connect to it and navigate through some or all of the possible audio menu paths. This may be done by a human in one embodiment of the invention. As the IVR system is parsed, the call completion system transcribes or maps the options. Once an organization's IVR menu is learned, it may be saved for future use and may be updated as the organization's menu changes. This may require the call completion system to revisit the IVR menu occasionally.

Whether the caller is given a real-time or off-line presentation, the IVR system options may be displayed for the caller in any form that facilitates his or her choice of their desired destination. Thus, one level of the audio menu may be presented at a time, with each choice yielding the suitable options at the next level (e.g., through a hyperlink). Alternatively, multiple levels may be presented together or multiple levels may be condensed to allow direct selection of a destination rather than being limited to the serial mode of operation of an IVR. In addition, a search tool may be provided so that the caller may search for possible destinations (e.g., “technical support,” “reservations”).

The mapped IVR menu may be presented on the caller's computer system (e.g., a desktop, portable), PDA, telephone, instant messaging device or some other compatible device, and may incorporate text, graphics or other forms of data. The presentation may be made immediately in response to the caller's request for a call with the organization, just before the call is to be completed, or at some other time.

After the caller identifies or specifies his or her destination in the IVR menu, the call completion system may place a call to the organization (or complete an ongoing call) or generate a call request to establish a call between them. If the caller's navigation was performed in real-time (i.e., while the caller is connected to the organization), the call completion system may withdraw from the connection after the last menu option is entered. Alternatively, and particularly if the caller is placed in a wait queue or there is reason to suspect that the desired party will not pick up the call for a while, the caller may be able to disconnect. In this case the call completion system will remain on-line and re-connect the caller at the appropriate time (e.g., when the called party answers). Additional options for minimizing a caller's waiting time are discussed below.

If the caller navigated the IVR menu off-line (i.e., rather than in real-time), he or she may disconnect from the call completion system after indicating a desired navigation path. The call completion system may then enter a call request from the caller for the organization, or attempt to complete the call immediately. When the call completion system initiates a connection between the caller and the organization, it may first call the organization and navigate the IVR system according to the caller's specifications.

Illustratively, the caller may not be connected (or notified that he or she is about to be connected) until after the IVR system has been navigated (e.g., with the appropriate DTMF (Dual Tone, Multi-Frequency) signals), after the desired party has answered, after the call has been placed into a wait queue, etc. For example, before the caller is connected or the desired party answers the call, the call completion system may repeatedly play a message asking that party to press a particular key or give some audible signal in order to connect the caller. The message may be recorded in the caller's voice.

Or, the caller may be connected when there is an indication that the desired party or destination (e.g., source of automated information) has answered or is about to answer (e.g., an indication—such as a countdown—may be provided by the organization). Illustratively, the call completion system may monitor its connection with the organization to detect a human voice pattern indicating than an organization representative has answered the call.

If, while navigating an organization's IVR system on behalf of a caller, the call completion system encounters an unexpected or new input, a call completion operator or the caller may be connected in order to respond or take appropriate action.

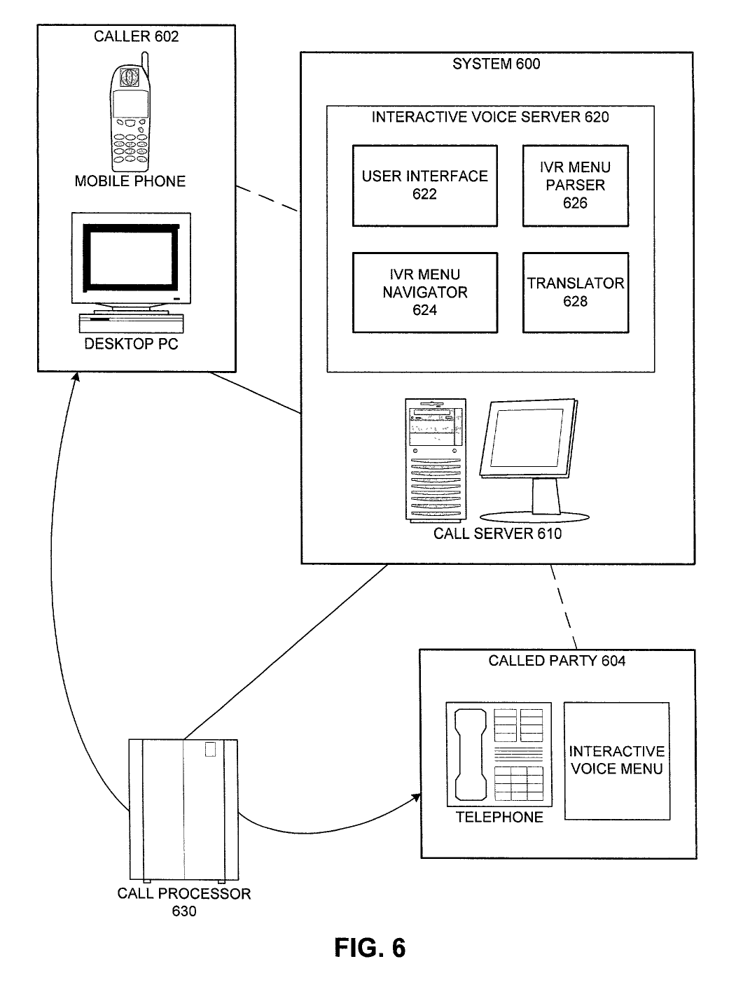

FIG. 6 demonstrates a system for facilitating a subscriber's navigation of an IVR system, according to one embodiment of the invention. System 600 comprises call server 610 for receiving call requests and/or initiating call connections using a call processor or a subscriber's communication device. Caller 602 and/or called party 604 may employ various communication and computing devices for interacting with system 600.

System 600 also includes IVR server 620 which may perform various functions of the web server and/or availability server of system 100 of FIG. 1. In particular, however, server 620 is configured to facilitate the caller's access to a called party entity through an interactive voice menu. In this embodiment, user interface 622 interacts with caller 602 to provide graphical counterparts to the called party's IVR menu options and receive the caller's selection of desired options. IVR menu navigator 624 then navigates the called party's IVR menu on behalf of the caller. Either IVR server 620 (e.g., navigator 624) or call server 610 may join the caller to a telephone connection with the called party.

IVR menu parser 626, in this embodiment, is configured to parse the called party's IVR menu. This may be done once (e.g., in response to the caller's request for a connection with called party 604) or may be done periodically to check for changes to the IVR menu. Translator 628 is configured to translate or transform the audio menu options offered by the called party's IVR system into graphical, textual or other visually displayable form for presentation to a caller.

The foregoing descriptions of embodiments of the invention have been presented for purposes of illustration and description only. They are not intended to be exhaustive or to limit the invention to the forms disclosed. Accordingly, the above disclosure is not intended to limit the invention; the scope of the invention is defined by the appended claims.

What is claimed is:

1. A method of establishing a voice connection between a first party and a second party, wherein neither of the first party and the second party knows the other party's telephone number used for the voice connection, the method comprising:
receiving from a first party a request for a voice connection with a second party, said request comprising an identifier of the second party other than a telephone number;
determining whether the second party is available for said voice connection; and
establishing said voice connection.

2. The method of claim 1, wherein said identifier is an electronic mail address.

3. The method of claim 1, wherein said identifier is an instant messaging system user name.

4. The method of claim 1, wherein said request further comprises a telephone number of the first party.

5. The method of claim 1, wherein said request further comprises information identifying the first party.

6. The method of claim 5, wherein said information includes one or more of: a name, an electronic mail address, an instant messaging user name and a picture.

7. The method of claim 1, wherein said determining comprises:
informing the second party of said voice connection request; and
receiving a response from the second party.

8. The method of claim 7, wherein said informing comprises:
providing to the second party information, other than a telephone number, for identifying the first party.

9. The method of claim 7, wherein said informing comprises:
sending to the second party one or more of an electronic mail message and an instant message.

10. The method of claim 7, wherein said response comprises a telephone number of the second party.

11. The method of claim 7, wherein said response comprises an approval of said voice connection request.

12. The method of claim 1, wherein said establishing comprises:
determining whether the second party is available for said voice connection.

13. The method of claim 1, wherein said establishing comprises:
determining whether the first party is available for said voice connection.

14. The method of claim 1, further comprising:
informing one of the first party and the second party of a fee charged by the other of the first party and the second party in conjunction with said voice connection.

15. The method of claim 14, wherein said request comprises said fee charged by the first party.

16. The method of claim 14, further comprising:
notifying the second party of said request; and
in response to said notifying, receiving from the second party a response to said request;
wherein said response to said request comprises said fee charged by the second party.

17. A computer readable storage medium storing instructions that, when executed by a computer, cause the computer to perform a method of establishing a voice connection between a first party and a second party, wherein neither of the first party and the second party knows the other party's telephone number used for the voice connection, the method comprising:
receiving from a first party a request for a voice connection with a second party, said request comprising an identifier of the second party other than a telephone number;
determining whether the second party is available for said voice connection; and
establishing said voice connection.

18. A method of establishing a telephone connection between a first party and a second party, comprising:
receiving from a first party a request for a telephone connection with a second party;
informing the second party of said request; and
if the second party approves said request, establishing said telephone connection between the first party and the second party, using a first telephone number associated with the first party and a second telephone number associated with the second party;
wherein said first telephone number remains unknown to the second party and said second telephone number remains unknown to the first party.

19. The method of claim 18, wherein said request includes an electronic mail address associated with the second party.

20. The method of claim 19, wherein said informing comprises sending an electronic mail message to the electronic mail address.

21. The method of claim 20, wherein said electronic mail message comprises information identifying the first party.

22. The method of claim 21, wherein said identifying information comprises a picture.

23. The method of claim 21, wherein said identifying information comprises a name.

24. The method of claim 21, wherein said identifying information comprises an address.

25. The method of claim 18, wherein said request includes an instant messaging identifier associated with the second party.

26. The method of claim 25, wherein said informing comprises sending an instant message to the instant messaging identifier.

27. The method of claim 26, wherein said instant message comprises information identifying the first party.

28. The method of claim 27, wherein said identifying information comprises a picture.

29. The method of claim 27, wherein said identifying information comprises a name.

30. The method of claim 27, wherein said identifying information comprises an address.

31. The method of claim 18, wherein said request for a telephone connection comprises said first telephone number.

32. The method of claim 18, further comprising receiving said second telephone number from the second party, in response to said informing.

33. The method of claim 18, wherein said establishing said telephone connection between the first party and the second party comprises:
determining the availability, for said telephone connection, of one or more of the first party and the second party.

34. A computer readable storage medium storing instructions that, when executed by a computer, cause the computer to perform a method of establishing a telephone connection between a first party and a second party, the method comprising:
receiving from a first party a request for a telephone connection with a second party;
informing the second party of said request; and
if the second party approves said request, establishing said telephone connection between the first party and the second party, using a first telephone number associated with the first party and a second telephone number associated with the second party;
wherein said first telephone number remains unknown to the second party and said second telephone number remains unknown to the first party.

35. A method of establishing a telephone connection between a first party and a second party, comprising:
receiving from a first party a request for a telephone connection with a second party, wherein said request includes a user name associated with the second party;
sending a communication to the second party using said user name; and
if the second party approves said request, establishing said telephone connection between the first party and the second party, using a first telephone number associated with the first party and a second telephone number associated with the second party;
wherein said first telephone number remains unknown to the second party and said second telephone number remains unknown to the first party.

36. The method of claim 35, wherein said user name is associated with a chat service.

37. The method of claim 35, wherein said user name is associated with an instant messaging service.

38. The method of claim 35, further comprising:
informing the second party of a fee charged by the first party in conjunction with said telephone connection.

39. The method of claim 38, wherein said request comprises said fee charged by the first party.

40. The method of claim 35, further comprising:
informing the first party of a fee charged by the second party in conjunction with said telephone connection.

41. The method of claim 40, wherein said fee charged by the second party is received by the second party in response to said communication.

42. A computer readable storage medium storing instructions that, when executed by a computer, cause the computer to perform a method of establishing a telephone connection between a first party and a second party, the method comprising:
receiving from a first party a request for a telephone connection with a second party, wherein said request includes a user name associated with the second party;
sending a communication to the second party using said user name; and
if the second party approves said request, establishing said telephone connection between the first party and the second party, using a first telephone number associated with the first party and a second telephone number associated with the second party;
wherein said first telephone number remains unknown to the second party and said second telephone number remains unknown to the first party.

43. A system for establishing a telephone connection between two parties without either party learning the other party's telephone number, comprising:
a call server configured to receive from a first party a request for a telephone connection with a second party, wherein said request identifies the second party with an identifier other than a telephone number;
a notifier configured to automatically communicate said request to the second party; and
a connection to a call processor configured to establish said telephone connection between the first party and the second party;
wherein said call server signals the call processor to establish said telephone connection when both the first party and the second party if the second party approves said request.

44. The system of claim 43, further comprising the call processor.

45. The system of claim 43, wherein the call processor establishes said telephone connection between a first telephone number associated with the first party and a second telephone number associated with the second party; and
wherein said first telephone number remains unknown to the second party and said second telephone number remains unknown to the first party.

46. The system of claim 43, wherein said request notification module notifies the second party of the request via an electronic mail message sent to an electronic mail address associated with the second party; and
wherein said identifier comprises said electronic mail address.

47. The system of claim 43, wherein said request notification module notifies the second party of the request via an instant message sent to an instant message user name associated with the second party; and
wherein said identifier comprises said instant message user name.

48. The system of claim 43, wherein said request comprises information identifying the first party; and
said request notification module is further configured to communicate said identifying information to the second party.

49. The system of claim 43, wherein said notifier is further configured to inform one of the first party and the second party of a fee requested by the other of the first party and the second party in conjunction with said telephone connection.
